(19) United States
(12) Patent Application Publication
(10) Pub. No.: US 2025/0383212 A1
(43) Pub. Date: Dec. 18, 2025

(54) TRIP PLANNING TECHNIQUES FACILITATING OPTIMAL DRIVING AND CHARGING DURING LONG JOURNEYS FOR ELECTRIFIED VEHICLES

(71) Applicant: FCA US LLC, Auburn Hills, MI (US)

(72) Inventors: Vivek Jairazbhoy, Auburn Hills, MI (US); Ludmila Leborgne, Poissy (FR); Stephane Maurel, Poissy (FR); Antoine Simon, Poissy (FR); Alfredo Wulf, Poissy (FR)

(21) Appl. No.: 18/743,443

(22) Filed: Jun. 14, 2024

(51) Int. Cl. G01C 21/34; B60L 58/12; G01C 21/36

(52) U.S. Cl. CPC G01C 21/3469; B60L 58/12; G01C 21/3415; G01C 21/3679; G01C 21/3691

(57) ABSTRACT

A trip optimization system for a trip of an electrified vehicle from a start point to an end point includes a control system configured to determine a first optimized trip plan based on at least an initial state of charge (SOC) of a high voltage battery system of the electrified vehicle, wherein the first optimized trip plan specifies a set of stops at respective set of charging stations to recharge the high voltage battery system and, during the trip of the electrified vehicle, selectively reoptimize the first optimized trip plan based on at least one of a change in a current position of the electrified vehicle and a change in environmental conditions to obtain a second optimized trip plan, and a driver interface configured to output information to a driver of the electrified vehicle relating to the first and second optimized trip plans.

### FIELD

The present application generally relates to electrified vehicles and, more particularly, to trip planning techniques facilitating optimal driving and charging during long journeys for electrified vehicles.

### BACKGROUND

Vehicle range can be a source of customer anxiety in relation to owning/operating an electrified vehicle and, more particularly, a battery electric vehicle (BEV). The limited vehicle range can affect both a route and duration of a longer trip, and the trip duration is also highly dependent on other factors such as charging station parameters and road parameters (e.g., road surface type and road grade). Conventional trip planning solutions exist that are provided by vehicle original equipment manufacturers (OEMs) and third-party applications, but customer reviews of these existing solutions are mixed and often negative. For example, one conventional solution is to merely provide a list of charging stations between a start and end point of the trip and the customer (driver) is left to decide or plan their stops of the vehicle by selecting one or more of the charging stations from the provided list. Accordingly, while such conventional trip planning and optimization techniques do work well for their intended purpose, there exists an opportunity for improvement in the relevant art.

### SUMMARY

According to one example aspect of the invention, a trip optimization system for a trip of an electrified vehicle from a start point to an end point is presented. In one exemplary implementation, the trip optimization system comprises a control system configured to determine a first optimized trip plan based on at least an initial state of charge (SOC) of a high voltage battery system of the electrified vehicle, wherein the first optimized trip plan specifies a set of stops at respective set of charging stations to recharge the high voltage battery system and, during the trip of the electrified vehicle, selectively reoptimize the first optimized trip plan based on at least one of a change in a current position of the electrified vehicle and a change in environmental conditions to obtain a second optimized trip plan, and a driver interface configured to output information to a driver of the electrified vehicle relating to the first and second optimized trip plans.

In some implementations, the control system is configured to determine the first optimized trip plan and the set of charging stations based on at least one of charging station location, capability, and availability. In some implementations, the control system is configured to determine the first optimized trip plan by minimizing a total cost of the trip. In some implementations, the total cost of the trip is (i) a time or duration of the trip or (ii) a total monetary cost of the trip relating to operating each of the set of charging stations.

In some implementations, the control system is configured to determine the first optimized trip plan based further on a set of driver preferences relating to electrified vehicle settings that affect energy consumption by the electrified vehicle. In some implementations, the set of driver preferences include at least one of a desired performance mode of the electrified vehicle and a desired cabin comfort setting of the electrified vehicle. In some implementations, the control system is further configured to determine the set of preferences and the start and end points for the trip from a remote server, and wherein the remote server is configured to determine the set of preferences and the start and end points for the trip from a mobile device associated with the driver based on previously-provided inputs via the mobile device.

In some implementations, the control system is configured to reoptimize the first optimized trip plan to obtain the second optimized trip plan by eliminating charging stations that are no longer between the current position of the electrified vehicle and the end point of the trip. In some implementations, the environmental factors comprise at least one weather condition, and wherein the at least one weather condition includes at least one of ambient temperature, wind speed, and wind direction. In some implementations, the environmental factors comprise at least one road condition, and wherein the at least one road condition includes at least one of road surface type, road grade, and road traffic conditions.

According to another aspect of the invention, a trip optimization method for a trip of an electrified vehicle from a start point to an end point is presented. In one exemplary implementation, the trip optimization method comprises determining, by a control system of the electrified vehicle, a first optimized trip plan based on at least an initial SOC of a high voltage battery system of the electrified vehicle, wherein the first optimized trip plan specifies a set of stops at respective set of charging stations to recharge the high voltage battery system, during the trip of the electrified vehicle, selectively reoptimizing, by the control system, the first optimized trip plan based on at least one of a change in a current position of the electrified vehicle and a change in environmental conditions to obtain a second optimized trip plan, and outputting, by the control system and via a driver interface of the electrified vehicle, information to a driver of the electrified vehicle relating to the first and second optimized trip plans.

In some implementations, the determining of the first optimized trip plan and the set of charging stations is performed based on at least one of charging station location, capability, and availability. In some implementations, the determining of the first optimized trip plan is performed by minimizing a total cost of the trip. In some implementations, the total cost of the trip is (i) a time or duration of the trip or (ii) a total monetary cost of the trip relating to operating each of the set of charging stations.

In some implementations, the determining of the first optimized trip plan is performed based further on a set of driver preferences relating to electrified vehicle settings that affect energy consumption by the electrified vehicle. In some implementations, the set of driver preferences include at least one of a desired performance mode of the electrified vehicle and a desired cabin comfort setting of the electrified vehicle. In some implementations, the method further comprises determining, by the control system, the set of preferences and the start and end points for the trip from a remote server, wherein the remote server is configured to determine the set of preferences and the start and end points for the trip from a mobile device associated with the driver based on previously-provided inputs via the mobile device.

In some implementations, the reoptimizing of the first optimized trip plan to obtain the second optimized trip plan is performed by eliminating charging stations that are no longer between the current position of the electrified vehicle and the end point of the trip. In some implementations, the environmental factors comprise at least one weather condition, and wherein the at least one weather condition includes at least one of ambient temperature, wind speed, and wind direction. In some implementations, the environmental factors comprise at least one road condition, and wherein the at least one road condition includes at least one of road surface type, road grade, and road traffic conditions.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having an example trip optimization system according to the principles of the present application; and

FIG. 2 is a flow diagram of an example trip optimization method for an electrified vehicle according to the principles of the present application.

### DESCRIPTION

As previously discussed, conventional vehicle trip planning and optimization solutions provided by vehicle original equipment manufacturers (OEMs) and third-party applications have mixed or negative customer reviews. For example, one conventional solution is to provide a list of charging stations between the start and end points of the trip and the customer (driver) is then left to decide or plan their stops of the vehicle by selecting one or more of the charging stations from the provided list.

Accordingly, improved trip planning and optimization techniques for electrified vehicles, such as battery electric vehicles (BEVs), are presented herein. These techniques determine a first (initial) optimized trip plan based on an initial state of charge (SOC) of the vehicle's battery system. The first optimized trip plan specified a set of one or more stops at a respective one or more charging stations for recharging a high voltage battery system of the electrified vehicle. This first optimized trip plan could be optimized, for example, based on charging station location/capability/availability to minimize the time/duration or monetary cost of the trip, with minimal input from the consumer. The trip planning techniques are also able to update the first optimized trip plan in real-time based on changes in the current location of the electrified vehicle, changes in battery system SOC, environmental conditions (weather conditions, road/traffic conditions, etc.), and other factors that impact the trip (e.g., a driver's specified level of cabin comfort, such as a cabin temperature or air conditioning setting).

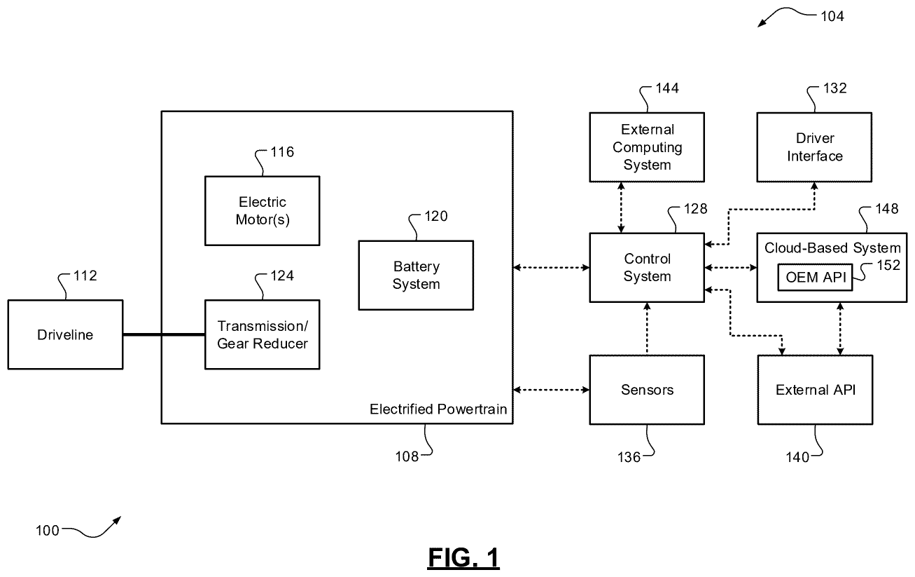

Referring now to FIG. 1, a functional block diagram of an electrified vehicle 100 having an example trip optimization system 104 according to the principles of the present application is illustrated. The electrified vehicle 100 generally comprises an electrified powertrain 108 configured to generate and transfer drive torque to a driveline 112 for propulsion. As shown, the electrified powertrain 108 includes an electric motor 116 (e.g., an electric traction motor) that is powered by electrical energy supplied by a high voltage battery system 120. The electric motor 116 is configured to transfer its generated torque directly, via a gear reducer, or via a transmission 124 (a multi-speed automatic transmission, a continuously variable transmission, etc.) to the driveline 112. In one exemplary implementation, the electrified vehicle 100 is a BEV as illustrated in FIG. 1. While not shown, however, it will be appreciated that the electrified vehicle 100 could be a hybrid electrified vehicle and the electrified powertrain 108 could include other energy sources, such as an internal combustion engine and/or a fuel cell system, for generating additional mechanical or electrical energy, such as for powering the driveline 112 or for recharging the battery system 120. A control system 128 controls operation of the electrified vehicle 100. This primarily includes controlling the electrified powertrain 108 to generate a desired amount of drive torque in satisfaction of a driver torque request received via a driver interface 132 (an accelerator pedal, a touch display, etc.).

The control system 128 can perform this control of the electrified powertrain 108 based further on measured operating parameters from a plurality of sensors 136. The plurality of sensors 136 are configured to measure operating parameters such as speeds/accelerations, pressures, temperatures, electrical parameters (voltage, current, etc.), and the like. The control system 128 is also configured to model other operating parameters of the electrified vehicle 100 based on at least some of these measured parameters. For example, a state of charge (SOC) of the battery system 120 could be modeled based on measured electrical parameters, such as using a Kalman filter type SOC estimation. In some implementations, at least some of the operating parameters (wind speed/direction, road surface type/grade, etc.) could be provided via an external application programming interface (API) 140 (e.g., a cloud-based server) via wireless (e.g., cellular) or “over-the-air” (OTA) communication. Some operations, such as training a power/energy consumption model for the electrified vehicle 100, which is discussed in greater detail below could also be performed by an external calibration or computing system 144. The control system 128 is also configured to perform at least a portion of the trip planning and optimization techniques of the present application, which will now be described in greater detail.

In some implementations, the trip optimization is at least partially performed by a cloud-based system 148. In this embodiment, the optimization algorithm could be run on the cloud-based system 148 (e.g., a cloud server) where it will have direct access to the third-party external API 140 (maps, weather, etc.) and/or an OEM API 152 (e.g., for detailed vehicles models and parameters). In such an embodiment, the cloud-based system 148 could have very substantial computing resources for execution of the optimization algorithm(s). After execution of the optimization algorithm(s) to optimize the vehicle trip, a final optimized trip plan is sent back to the electrified vehicle 100, where it is displayed and monitored for changes/updates as discussed in greater detail below.

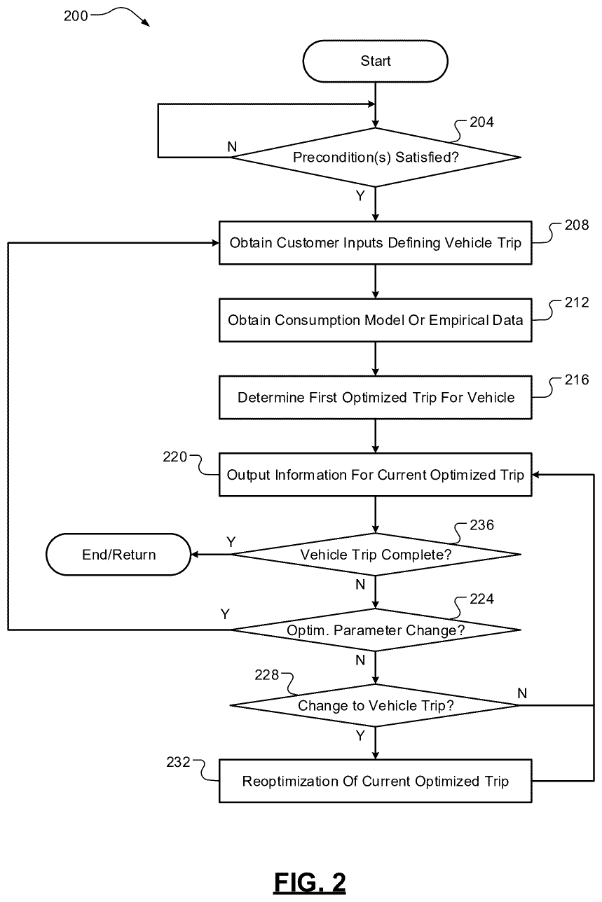

Referring now to FIG. 2, a flow diagram of an example trip optimization method 200 for an electrified vehicle according to the principles of the present application is illustrated. While the method 200 specifically references the electrified vehicle 100 and its components for illustrative/descriptive purposes, it will be appreciated that the method 200 could be applicable to any suitably configured electrified vehicle. The method 200 begins at 204. At 204, the control system 128 optionally determine whether a set of one or more preconditions are satisfied. These precondition(s) could include, for example only, the electrified vehicle 100 being powered up and running, a start and end point for an upcoming vehicle trip having been provided by the customer (note that this step could be performed later as shown), and there being no malfunctions or faults present that would negatively impact or otherwise inhibit the operation of the techniques of the present application. When false, the method 200 ends or returns to 204.

When true, the method 200 continues to 208. At 208, the control system 128 obtains a set of customer parameters defining the upcoming vehicle trip. This includes, for example, a start and end point for the vehicle trip and a current SOC of the battery system 120. The set of customer parameters could also include customer-specific parameters relating to the operation of the electrified vehicle 100 such as, but not limited to, an operating mode of the electrified powertrain 108 (normal, sport, eco, etc.) and a desired level of cabin comfort (e.g., temperature settings, such as air conditioning system settings).

In some implementations, this information is providable by the customer (e.g., the driver) via their personal computing device, such as their mobile phone. For example only, this could be described as an initial planning stage, which the customer could perform at his/her home, such as while sitting on the couch the night before the planned vehicle trip. At 212, the control system 128 obtains a power or energy consumption model for the electrified vehicle. This consumption model could be, for example, a trained neural network-type model that is configured to estimate a power or energy consumption of the electrified vehicle 100 in real-time based on various operating parameters of the electrified vehicle 100 and could be obtained from the external calibration or computing system 144. These operating parameters include both operating parameters of the electrified vehicle 100 itself and also environmental conditions that the electrified vehicle 100 is expected to encounter (temperature, wind, road surface/grade, traffic, etc.). While a trained neural network-type consumption model is specifically described, it will be appreciated that other consumption estimation techniques for the electrified vehicle 100 could also be used, such as empirical estimation techniques based on one or more detailed look-up tables.

At 216, using the set of customer parameters defining the upcoming vehicle trip and the consumption model or similar empirical-based techniques, the control system 128 determines a first optimized trip for the electrified vehicle 100. The first optimized trip defines a set of stops at a set of respective charging stations for recharging of the electrified vehicle 100 along a route from the start point to the end point. These charging station stops could be optimized based on the previously-determined or expected availability of the charging stations along with their known capabilities and costs of operation (e.g., based on information from the external API 140). For example, the first optimized trip for a more cost-conscious driver could avoid higher cost charging stations in favor of other charging stations that would result in a slightly longer duration vehicle trip.

At 220, the control system 128 outputs, via the driver interface 132 (e.g., a display) information relating to the current (first) optimized trip. This could include, for example, directions and a distance to the next charging station stop. This outputting of information relating to the current (first) optimized trip can continue until a vehicle route/location change occurs that causes a reoptimization of the current (first) optimized trip to obtain a different (second) optimized trip or until the driver provides new/modified optimization parameter(s), in which the optimization process could restart at 208.

More specifically, at 224, the control system 128 determines whether a change has occurred that potentially affects the current (first) optimized trip. For example, the customer (driver) may change their preference relating to charging cost versus trip length/duration or a change in weather/traffic could be detected (e.g., based on information from the external API 140) that affects the previously-planned route according to the current (first) optimized trip. Alternatively, the driver could entirely change the optimization parameters (or just a few optimization parameters) from the original optimization parameters. When true, the method 200 returns to 208 and the optimization procedure starts over. When false, the method 200 proceeds to 228.

At 228, the control system 128 determines whether there is a change in the vehicle trip (e.g., whether the driver has strayed from the provided optimized plan). When false, the method 200 returns to 220. When true, the method 200 proceeds to 232. At 232, the control system 128 reoptimizes the current (first) optimized trip based on the changes to the vehicle trip (e.g., a change in the vehicle location) to obtain a different (second) optimized trip. The method 200 then returns to 220 where the control system 128 outputs, via the driver interface 132, information relating to the current (second) optimized trip similar to the outputting of information relating to the previously (first) optimized trip described above. At 236, the control system 128 determines whether the vehicle trip has ended or completed. When true, the method 200 ends or returns to 204. When false, the method 200 returns to 220 and the information outputting and selective reoptimization of the optimized trip continues until the vehicle trip is completed.

In some implementations, the optimized trip or optimized plan could also include (i) the amount of energy that has to be charged at each charging station stop and (ii) a speed profile (e.g., as a function of distance along the trip) that will fit the optimization objectives. For example, the speed profile or speed target could be displayed to the driver via the driver interface 132 or could be directed to a cruise control function during the process (e.g., step 220). In some implementations, more complex objectives could be considered. For example, in addition to the already described optimization parameters such as trip duration and charging costs, other parameters such as road toll costs, battery aging (e.g., a hard constraint limiting the aging to a certain value by trip, mileage or duration), and/or weighted objectives added to the other objectives.

These objectives would be selected and weighted by factors defined by the driver during the process (e.g., step 208). In yet other implementations, other optimization parameters could be added to or included in the process (e.g., step 208). These could include, for example only, (i) an SOC target at the end of trip (e.g., to allow the driver to keep or not keep an energy stock/supply for another future trip; for example, maybe the driver will be able to charge at a final stop, or the driver will have to reserve some energy for a next trip), (ii) a minimal SOC along the trip (e.g., to secure the driver that he will always have a certain minimal amount of energy). Additionally, during the trip (along the route), the driver should have the capability to manually add (i) charging stops/waypoints, (ii) stops/waypoints for restaurant or tourism specifying a targeted pause time.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A trip optimization system for a trip of an electrified vehicle from a start point to an end point, the trip optimization system comprising:
a control system configured to:
determine a first optimized trip plan based on at least an initial state of charge (SOC) of a high voltage battery system of the electrified vehicle, wherein the first optimized trip plan specifies a set of stops at respective set of charging stations to recharge the high voltage battery system; and
during the trip of the electrified vehicle, selectively reoptimize the first optimized trip plan based on at least one of a change in a current position of the electrified vehicle and a change in environmental conditions to obtain a second optimized trip plan; and
a driver interface configured to output information to a driver of the electrified vehicle relating to the first and second optimized trip plans.

2. The trip optimization system of claim 1, wherein the control system is configured to determine the first optimized trip plan and the set of charging stations based on at least one of charging station location, capability, and availability.

3. The trip optimization system of claim 1, wherein the control system is configured to determine the first optimized trip plan by minimizing a total cost of the trip.

4. The trip optimization system of claim 3, wherein the total cost of the trip is (i) a time or duration of the trip or (ii) a total monetary cost of the trip relating to operating each of the set of charging stations.

5. The trip optimization system of claim 1, wherein the control system is configured to determine the first optimized trip plan based further on a set of driver preferences relating to electrified vehicle settings that affect energy consumption by the electrified vehicle.

6. The trip optimization system of claim 5, wherein the set of driver preferences include at least one of a desired performance mode of the electrified vehicle and a desired cabin comfort setting of the electrified vehicle.

7. The trip optimization system of claim 5, wherein the control system is further configured to determine the set of preferences and the start and end points for the trip from a remote server, and wherein the remote server is configured to determine the set of preferences and the start and end points for the trip from a mobile device associated with the driver based on previously-provided inputs via the mobile device.

8. The trip optimization system of claim 1, wherein the control system is configured to reoptimize the first optimized trip plan to obtain the second optimized trip plan by eliminating charging stations that are no longer between the current position of the electrified vehicle and the end point of the trip.

9. The trip optimization system of claim 1, wherein the environmental factors comprise at least one weather condition, and wherein the at least one weather condition includes at least one of ambient temperature, wind speed, and wind direction.

10. The trip optimization system of claim 1, wherein the environmental factors comprise at least one road condition, and wherein the at least one road condition includes at least one of road surface type, road grade, and road traffic conditions.

11. A trip optimization method for a trip of an electrified vehicle from a start point to an end point, the trip optimization method comprising:
determining, by a control system of the electrified vehicle, a first optimized trip plan based on at least an initial state of charge (SOC) of a high voltage battery system of the electrified vehicle, wherein the first optimized trip plan specifies a set of stops at respective set of charging stations to recharge the high voltage battery system;
during the trip of the electrified vehicle, selectively reoptimizing, by the control system, the first optimized trip plan based on at least one of a change in a current position of the electrified vehicle and a change in environmental conditions to obtain a second optimized trip plan; and
outputting, by the control system and via a driver interface of the electrified vehicle, information to a driver of the electrified vehicle relating to the first and second optimized trip plans.

12. The trip optimization method of claim 11, wherein the determining of the first optimized trip plan and the set of charging stations is performed based on at least one of charging station location, capability, and availability.

13. The trip optimization method of claim 11, wherein the determining of the first optimized trip plan is performed by minimizing a total cost of the trip.

14. The trip optimization method of claim 13, wherein the total cost of the trip is (i) a time or duration of the trip or (ii) a total monetary cost of the trip relating to operating each of the set of charging stations.

15. The trip optimization method of claim 11, wherein the determining of the first optimized trip plan is performed based further on a set of driver preferences relating to electrified vehicle settings that affect energy consumption by the electrified vehicle.

16. The trip optimization method of claim 15, wherein the set of driver preferences include at least one of a desired performance mode of the electrified vehicle and a desired cabin comfort setting of the electrified vehicle.

17. The trip optimization method of claim 15, further comprising determining, by the control system, the set of preferences and the start and end points for the trip from a remote server, wherein the remote server is configured to determine the set of preferences and the start and end points for the trip from a mobile device associated with the driver based on previously-provided inputs via the mobile device.

18. The trip optimization method of claim 11, wherein the reoptimizing of the first optimized trip plan to obtain the second optimized trip plan is performed by eliminating charging stations that are no longer between the current position of the electrified vehicle and the end point of the trip.

19. The trip optimization method of claim 11, wherein the environmental factors comprise at least one weather condition, and wherein the at least one weather condition includes at least one of ambient temperature, wind speed, and wind direction.

20. The trip optimization method of claim 11, wherein the environmental factors comprise at least one road condition, and wherein the at least one road condition includes at least one of road surface type, road grade, and road traffic conditions.
